(19) United States
(12) Patent Application Publication
(10) Pub. No.: US 2019/0156981 A1
(43) Pub. Date: May 23, 2019

(54) Electromagnetic Actuating Apparatus With A D-Shaped Coil For A Two-Pin Actuator

(71) Applicant: Kendrion (Villingen) GmbH, Villingen-Schwenningen (DE)

(72) Inventors: Tsuneo Suzuki, Mönchweiler (DE); Michael Tischtschenko, Trossingen (DE); Aleksandra Lech, Villingen-Schwenningen (DE)

(73) Assignee: Kendrion (Villingen) GmbH, Villingen-Schwenningen (DE)

(21) Appl. No.: 16/091,454

(22) PCT Filed: Apr. 21, 2017
(86) PCT No.: PCT/EP2017/059566

§ 371 Date: Oct. 4, 2018

(30) Foreign Application Priority Data
Apr. 25, 2016 (DE) 10 2016 107 661.9

(51) Int. Cl. H01F 7/16; H01F 7/08; H01F 27/00; F01L 13/00

(52) U.S. Cl. CPC H01F 7/1607; H01F 7/081; F01L 2013/101; F01L 13/0015; H01F 2007/086; H01F 27/006

(57) ABSTRACT

An actuating apparatus having a first actuating unit and a second actuating unit arranged adjacent to the first actuating unit. The actuating units each have elongated tubular coil bodies, actuator coils which are wound around the coil bodies, electromagnetically actuatable actuators which are guided in the coil bodies and are movable relative to the actuator coils, and the coil bodies are D-shaped and face one another with the flattened sides thereof.

This invention relates to an actuating device, particularly a cam shaft actuating device as described in the introductory clause of claim 1.

Actuating apparatuses having electromagnetically actuatable actuator units comprising actuating elements with end-side engaging surfaces for axially adjusting the engaging surface in a first direction, as well as resetting units for resetting the engaging surface into a second direction which is opposite to said first direction, are for example known from DE 102 40 774 A1 and are used for various applications, for example as cam shaft actuating apparatuses in motor vehicles. The basic principle of these known actuating apparatuses is that a piston as the actuating element, which comprises an engaging area for the intended actuating task on its end sides, is guided in a housing and can be moved out of the housing against the force of a resetting spring using an electromagnetically actuatable actuator unit provided in the housing.

Also known are valve lift adjusting apparatuses, which can change a position of a sliding member which rotates together with the cam shaft and moves axially relative to the cam shaft. Valve lift adjusting apparatuses coordinate lift amounts of inlet valves and outlet valves of an internal combustion engine. In vehicles, for example, drivers can switch from a sporty to a fuel-efficient driving style by toggling a switch.

An electromagnetic actuator is used for changing the position of the sliding member. This actuator alternatively moves one of two control pins in accordance with a direction of movement of the sliding member, such that a tip of the control pin is brought into engagement with an engaging groove formed in the sliding member. DE 10 2009 015 86 A1, for example, discloses such an electromagnetic actuator having two control pins. A permanent magnet is provided on one base end of each control pin. The polarity of the permanent magnets is opposite to each other in a direction of movement of the control pins. When a coil is excited to generate a magnetic field, a repulsive force is generated in one of the permanent magnets and an attractive force is generated in the other permanent magnet.

This moves the control pin with the permanent magnet that generates the repulsive force. When the excitation direction of the coil is changed, a magnetic flux direction of the magnetic field becomes the opposite direction, such that the other control pin is moved.

To generate a repulsive force that is sufficiently great to improve the response rate of the control pins, the coil and the permanent magnet must be respectively larger. Furthermore, since the permanent magnet moves together with the control pins, the weight of one of the moving elements increases when the permanent magnet is dimensioned larger, and the coil must generate a greater electromagnetic force.

DE 10 2013 206 311 A1 discloses an invention in which an electromagnetic actuator is provided which can improve a response rate of a control pin. For this purpose, an electromagnetic actuator is applied to a valve lift adjusting apparatus, which adjusts a lift amount of an inlet valve or an outlet valve of an internal combustion engine. Two control pins arranged adjacent to each other are energized by a single coil, which is conducted around both control pins. Two permanent magnets, each located at a base end of the control pin, ensure that, when the coil is energized, either the one control pin or the other control pin is moved downwards towards the cam shaft, depending on the polarity of the energization. It is a disadvantage of this arrangement that thick and massive permanent magnets must be provided in the electromagnetic actuator to achieve a sufficient response rate of the control pins. The exciter coil must also be thick and massive, which additionally increases the weight of the electromagnetic actuator. If one wants to work with electromagnetic actuators of lower weight, each control pin must be given its own exciter coil, which increases the spacing between the two control pins quite considerably. This again requires a wider valve lift adjusting apparatus.

This is where the present invention comes into play.

It is the problem of this invention to provide an electromagnetic actuator whose response rate is very high and which comprises two control pins which should be spaced apart as little as possible.

This problem is solved by an actuating apparatus according to claim 1. Advantageous embodiments are disclosed in the dependent claims.

This is achieved by an actuating apparatus having a first actuating unit and a second actuating unit arranged adjacent to the first actuating unit. The actuating units each comprise elongated tubular coil bodies, actuator coils, which are wound around the coil bodies, and electromagnetically actuatable actuators, which are guided in the coil bodies and are movable relative to the actuator coils. The coil bodies are D-shaped and face one an other with the flattened sides thereof.

In detail, the actuating apparatus according to the invention comprises a first actuating unit having a first elongated tubular coil body, a first actuator coil, which is wound around the first coil body, and a first actuator which can be electromagnetically actuated by the first actuator coil, which actuator is guided in the first coil body and movable relative to the first actuator coil. The actuating apparatus further comprises a second actuating unit arranged adjacent to the first actuating unit, having a second elongated tubular coil body, a second actuator coil, which is wound around the second coil body, and a second actuator which can be electromagnetically actuated by the second actuator coil, which actuator is guided in the second coil body and movable relative to the second actuator coil. According to the invention, the first actuator coil comprises an outer solid peripheral line with an arcuate section and a straight section configured as a chord along at least one section of its longitudinal axis and in cross section perpendicular to its longitudinal axis. The first coil body thus has a D-shaped structure. A reduction of the spacing between the first actuator and the second actuator, that is, a reduction of the spacing of the two control pins apart from one another, can be achieved by this measure alone.

The longitudinal axis of the first coil body and the longitudinal axis of the second coil body, or the axes of the two directions of movement of the two actuators, respectively, are advantageously oriented parallel to one another.

The spacing of the two actuators relative to one another can further be reduced in that the second coil body also comprises an outer solid peripheral line with an arcuate section and a straight section configured as a chord along at least one section of its longitudinal axis and in cross section perpendicular to its longitudinal axis, wherein the two actuating units are preferably arranged relative to one another such that their sections configured as chords are facing one another.

The circular arc of the arcuate section advantageously has a center point angle of at least 120°, preferably between 180° and 300°.

It is preferred that the coil bodies have equal diameters, and advantageously equal sections in cross section. This means that both the arcuate sections and the straight sections configured as chords have the same dimensions.

The spacing of the actuators from one another can further be reduced in that the first actuator coil on the first actuating unit and the second actuator coil on the second actuating unit are arranged at an offset to one another. The first actuator coil and the second actuator coil are preferably wound in the same winding direction.

The first actuator coil and the second actuator coil are preferably electrically connected in series. In this way, a single control pulse can be used to energize the one actuator coil and the other actuator coil, such that, if the actuator coils are arranged at an offset, the one actuator is accelerated downwards while the other actuator is accelerated upwards, in the opposite direction.

A further reduction in the spacing of the two actuators relative to one another can be achieved in that the second actuator coil partially covers the first actuator coil of the first coil body in a viewing direction along the longitudinal axis of the first coil body.

The actuators preferably comprise an outer solid peripheral line at least along a section of their respective longitudinal axes and in cross section perpendicular to their longitudinal axes, which peripheral line has an arcuate section and a straight section configured as a chord, wherein the sections configured as chords are preferably facing one another. The two actuating units can be controlled selectively or jointly, wherein the actuator are oriented substantially axially parallel to one another.

Actuating apparatuses of the type described herein can for example be used as cam shaft actuating apparatuses.

The actuating apparatus according to the invention is explained in greater detail below with reference to specific embodiments. Wherein:

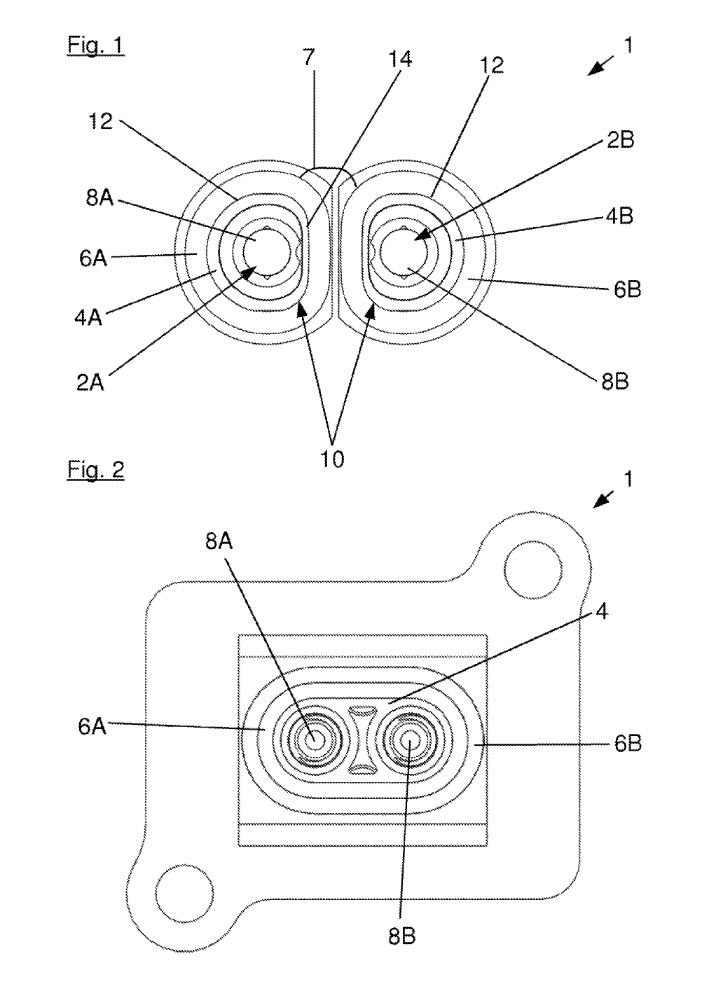

FIG. 1 shows a top view of an actuating apparatus in the direction of the two longitudinal axes of the coil bodies,

FIG. 2 shows the actuating apparatus of FIG. 1 in the same sectional view,

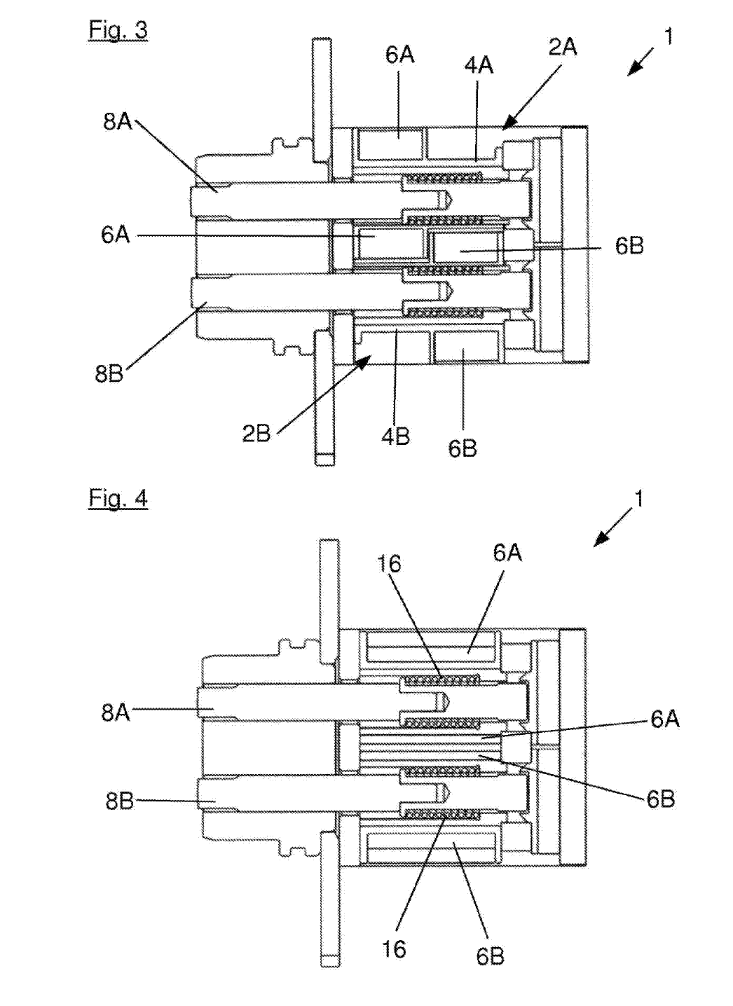

FIG. 3 shows a sectional view of a first embodiment of an actuating apparatus perpendicular to the top view along the longitudinal axes of the two coil bodies,

FIG. 4 shows a sectional view of a second embodiment of an actuating apparatus perpendicular to the top view along the longitudinal axes of the two coil bodies.

FIG. 1 shows an actuating apparatus 1 having a first actuating unit 2a and a second actuating unit 2b. The first actuating unit 2a comprises a first coil body 4a, the second actuating unit 2b comprises a second coil body 4b. A first actuator coil 6a is wound onto the first coil body 4a. A second actuator coil 6b is wound onto the second coil body 4b. The actuator coils 6a and 6b can be connected via electrical connecting lines 7. For example, a specific number of windings, for example four windings, can initially be applied onto the coil body 4a and for example form the first actuator coil 6a. At the end of these windings, the actuator coil 6a can be continued on the second coil body 4b, for example by also winding four windings onto the second coil body 4b, which then form the second actuator coil 6b. Another option is to conduct multiple windings around both coil bodies 4a, 4b, or fewer windings, but at least one winding. Another option is to alternately wind one or several windings around the first coil body 4a, then one of several around the second coil body 4b, then again one or several windings around the first coil body 4a and so on, such that the windings around the first coil body 4a form the first actuator coil 6a and the windings around the second coil body 4b form the second actuator coil 6b.

The coil bodies 4a, 4b have a D-shaped structure and are directed toward one another or directed in opposition to one another with the flattened sides thereof. Actuators 8a, 8b are arranged in the interior of the coil bodies 4a. 4b and movably guided along the longitudinal axes of the coil bodies 4a, 4b.

The coil bodies 4a, 4b each comprise outer peripheral lines 10, each having an arcuate section 12 and a straight section 14. The straight sections 14 of the two coil bodies 4a, 4b are oriented in this example such that they face one another. The first actuator 8a and the second actuator 8b have a cylindrical design. The two actuators 8a, 8b can also be D-shaped like the coil bodies 4a, 4b and be directed in opposition to one another with the flattened sides thereof.

FIG. 2 shows another actuating apparatus 1. The coil bodies 4a, 4b are integrally formed into one coil body 4. The windings of the first actuator coil 6a and the windings of the second actuator coil 6b each orbit the two actuators 8a, 8b and can be arranged on top of one another or at an offset to one another on the coil body 4. The actuator coils 6a and 6b can be energized in opposite directions, such that the magnetic flux through the actuator coil 6b can neutralize the magnetic flux through actuator coil 6a.

FIG. 3 shows a first embodiment of an actuating apparatus 1 having a first actuating unit 2a and a second actuating unit 2b. The first actuator coil 6a is in this case arranged at a spatial offset to the second actuator coil 6b in the actuating apparatus 1. The actuator coils 6a, 6b, which in this example may for example be wound in the same winding direction and electrically connected in series, partially cover one another in the viewing direction along the longitudinal axis of the first coil body 4a.

FIG. 4 shows a second embodiment of an actuating apparatus 1 having a first actuating unit 2a and a second actuating unit 2b along the longitudinal axes of the coil bodies 4a, 4b. In this embodiment, the two actuator coils 6a and 6b are arranged in parallel next to one another and not at an offset to one another. Resetting springs 16 ensure that the electromagnetically deflected actuators 8a, 8b are returned to their initial positions when the electric magnets 6a, 6b are no longer energized.

The invention was explained with reference to two embodiments, without being limited to these embodiments. A person skilled in the art can conceive numerous modifications and designs of the apparatus according to the invention without deviating from the inventive idea.

### LIST OF REFERENCE SYMBOLS

1 actuating apparatus
2a first actuating unit
2b second actuating unit
4a first coil body
4b second coil body
4 coil body
6a first actuator coil
6b second actuator coil
7 electrical connecting lines
8a first actuator
8b second actuator
10 peripheral line
12 arcuate section
14 straight section
16 resetting springs

1. An actuating apparatus, comprising:
a first actuating unit comprising:
a first elongated tubular coil body,
a first actuator coil, which is wound around the first elongated tubular coil body,
a first actuator that is electromagnetically actuated by the first actuator coil, which first actuator is guided in the first elongated tubular coil body and movable relative to the first actuator coil,
a second actuating unit arranged adjacent to the first actuating unit, the second actuating unit comprising:
a second elongated tubular coil body,
a second actuator coil, which is wound around the second coil body,
a second actuator that is electromagnetically actuated by the second actuator coil, which second actuator is guided in the second coil body and movable relative to the second actuator coil,
wherein the first actuator coil comprises an outer solid peripheral line with an arcuate section and a straight section configured as a chord along at least one section of a longitudinal axis of the first actuator coil and in cross section perpendicular to the longitudinal axis.

2. The actuating apparatus according to claim 1, wherein the longitudinal axis of the first coil body and a longitudinal axis of the second coil body are oriented parallel to one another.

3. The actuating apparatus according to claim 1, wherein the second actuator coil comprises an outer solid peripheral line with an arcuate section and a straight section configured as a chord along at least one section of a longitudinal axis and in cross section perpendicular to the longitudinal axis.

4. The actuating apparatus according to claim 1, wherein the circular arc of the arcuate section has a center point angle of at least 120 degrees.

5. The actuating apparatus according to claim 3, wherein the first actuating unit and the second actuating unit are arranged relative to one another such that their straight sections configured as chords are facing one another.

6. The actuating apparatus according to claim 1, wherein the first actuator coil on the first actuating unit and the second actuator coil on the second actuating unit are arranged at an offset from one another.

7. The actuating apparatus according to claim 1, wherein the first actuator coil and the second actuator coil are wound in the same winding direction.

8. The actuating apparatus according to claim 1, wherein the first actuator coil and the second actuator coil are electrically connected in series.

9. The actuating apparatus according to claim 1, wherein the first actuator and the second actuator comprise an outer solid peripheral line at least along a section of their respective longitudinal axes and in cross section perpendicular to their longitudinal axes, which peripheral line has an arcuate section and a straight section configured as a chord, wherein the sections configured as chords are preferably oriented facing one another.

10. The actuating apparatus according to claim 1, wherein the first actuating unit and the second actuating unit are controlled selectively, wherein the first actuator and the second actuator are substantially oriented axially parallel to one another.

11. A cam shaft adjusting apparatus, comprising at least one actuating apparatus according to claim 1.

12. An actuating apparatus, comprising:
a first actuating unit comprising:
a first coil body;
a first actuator coil having a first actuator coil longitudinal axis, wherein the first actuator coil is wound around the first coil body;
a first actuator that is electromagnetically actuated by the first actuator coil, wherein the first actuator is guided in the first coil body and movable relative to the first actuator coil;
wherein the first actuator coil comprises an first arcuate section and a first straight section configured as a first chord along at least one section of first actuator coil longitudinal axis and in cross section perpendicular to the first actuator coil longitudinal axis;
a second actuating unit arranged adjacent to the first actuating unit, the second actuating unit comprising:
a second coil body;
a second actuator coil having a second actuator coil longitudinal axis, wherein the second actuator coil is wound around the second coil body;
a second actuator that is electromagnetically actuated by the second actuator coil, wherein the second actuator is guided in the second coil body and movable relative to the second actuator coil;
wherein the second actuator coil comprises a second arcuate section and a second straight section configured as a second chord along at least one section of second actuator coil longitudinal axis and in cross section perpendicular to the second actuator coil longitudinal axis; and
the first actuator coil longitudinal axis is parallel to the second actuator coil longitudinal axis.

13. The actuating apparatus according to claim 12, wherein the circular arc of the arcuate section has a center point angle of at least 120 degrees.

14. The actuating apparatus according to claim 12, wherein the circular arc of the arcuate section has a center point angle of between 180 degrees and 300 degrees.

15. The actuating apparatus according to claim 12, wherein the first actuating unit and the second actuating unit are arranged relative to one another such that the first straight section configured as a first chord is facing the second straight section configured as a second chord.
